(19) United States
(12) Patent Application Publication
(10) Pub. No.: US 2016/0316965 A1
(43) Pub. Date: Nov. 3, 2016

(54) Charcoal Grill With Improved Thermal Efficiency

(71) Applicant: Hsinhan Wu, San Jose, CA (US)

(72) Inventor: Hsinhan Wu, San Jose, CA (US)

(21) Appl. No.: 14/699,343

(22) Filed: Apr. 29, 2015

(51) Int. Cl. A47J 37/07

(52) U.S. Cl. CPC A47J 37/0763

(57) ABSTRACT

Various implementations of a grill are described. A grill may include a grill body, a lid, a lower grate, an upper grate, a thermal-insulating blanket and a thermal-insulating wall. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid. The thermal-insulating wall may be disposed in the hollow of the grill body and between the lower grate and the upper grate. The thermal-insulating wall may surround at least a portion of an interior surface of the grill body

### TECHNICAL FIELD

The present disclosure relates to grills, and more particularly to a charcoal grill with improved thermal efficiency.

### BACKGROUND

Unless otherwise indicated herein, approaches described in this section are not prior art to the claims listed below and are not admitted to be prior art by inclusion in this section.

A grill, also known as barbeque (BBQ) grill, is a device for cooking food by applying heat directly from below. There are generally two main types of grills, namely gas-fueled grills and charcoal grills. Charcoal grills use either charcoal briquettes or all-natural lump charcoal for fuel. Charcoal, when burned, will transform into embers radiating the heat necessary to cook food. There are different charcoal grill configurations. Some grills are square, round, or rectangular. Some have lids while others do not. Some may or may not have a venting system for heat control.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide a grill with improved thermal efficiency to achieve high heat and longer lasting heat compared to conventional charcoal grills. A grill in accordance with the present disclosure may also be used as a pizza oven.

In one aspect, a grill may include a grill body, a lid, a lower grate, an upper grate and a thermal-insulating blanket. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid.

In another aspect, a grill may include a grill body, a lid, a lower grate, an upper grate, a thermal-insulating blanket and a thermal-insulating wall. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid. The thermal-insulating wall may be disposed in the hollow of the grill body and between the lower grate and the upper grate. The thermal-insulating wall may surround at least a portion of an interior surface of the grill body.

In yet another aspect, a grill may include a grill body, a lid, a lower grate, an upper grate, a thermal-insulating blanket, a thermal-insulating wall, a fuel holder and a metal plate. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid. The thermal-insulating blanket may include glass fibers, ceramic fibers or a combination thereof. The thermal-insulating wall may be disposed in the hollow of the grill body and between the lower grate and the upper grate. The thermal-insulating wall may surround at least a portion of an interior surface of the grill body. The thermal-insulating wall may include a ceramic material or a thermal-insulating material. The fuel holder may be configured to hold the fuel material therein, and may be configured to be placed between the lower grate and the upper grate. The metal plate may be configured to function as a diffuser, and may be disposed on the fuel holder.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a cross-sectional view of an example grill in accordance with an embodiment of the present disclosure.

FIG. 2 is another cross-sectional view of the example grill of FIG. 1.

### DETAILED DESCRIPTION OF PREFERRED EMBODIMENTS

### Overview

Advantages provide by a grill in accordance with the present disclosure are multi-fold. Firstly, implementations of present disclosure provide improved thermal efficiency by reducing thermal conductivity between heat source and outside elements for a grill. Secondly, implementations of the present disclosure provide improved localized heat source for cooking with the grill. Thirdly, implementations of the present disclosure provide improved indirect heat surface area. Detailed description of each of the aforementioned advantages is provided below.

To provide improved thermal efficiency by reducing thermal conductivity between heat source and outside elements for a grill, implementations of the present disclosure may utilize an insulated ceramic or any other suitable non-harmful thermal-insulating material to provide a thermal-insulating wall around the heat source to minimize heat transfer from the heat source to outside of the grill. The thermal-insulating wall may be divided into multiple pieces for ease of manufacturing, packaging and user handling and installation. Alternatively, the thermal-insulating wall may be made of one monolithic piece. Moreover, a thermal-insulating blanket may be provided and disposed on and around a lid of the grill to help trap heat and prevent the heat from escaping the lid of the grill. The thermal-insulating blanket may be made of glass fibers, ceramic fibers or a combination thereof, or any other suitable thermal-insulating material. In some implementations, thermal-insulating filling fibers may be inserted in the thermal-insulating blanket for additional heat insulation. With the use of a thermal-insulating wall and thermal-insulating blanket, consumption of fuel, e.g., charcoal or another suitable fuel, may be reduced. Additionally, with the use of a thermal-insulating wall and thermal-insulating blanket, the duration of the heat level for longer period of cooking time, e.g., smoking, or lower heat cooking may be enhanced. Furthermore, grill effectiveness may be maintained when used in colder climate.

To provide improved localized heat source for cooking with the grill, implementations of the present disclosure may utilize a generally cylindrical-shaped fuel holder to hold the fuel material therein. Alternatively, a generally column-shaped fuel holder that sits between the lower and upper grates of the grill may be utilized. This design feature maximizes the height of the fuel holder to increase the capacity of the fuel used in the grill to maximize the localized heat output for greater searing effectiveness.

To provide improved indirect heat surface area, implementations of the present disclosure may utilize a cast iron diffuser over the top of the fuel holder to cover the flame. The diffuser allows re-gaining of direct heat surface area to be used for indirect heat cooking. This design feature provides a number of benefits and advantages. Firstly, grill surface area may be regained for indirect heat cooking after searing is completed. Besides, cooking capacity is also increased. Secondly, even-heating is provided to the entire grill when used with the thermal-insulating wall and thermal-insulating blanket. This can turn the grill into a high-temperature oven. With the use of a pizza stone or pizza pan, sitting on top of the upper grate of the grill, the grill may be used to bake pizza. Thirdly, the cast iron may be used as a skillet when it sits on top of the upper grate of the grill.

### Example Implementations

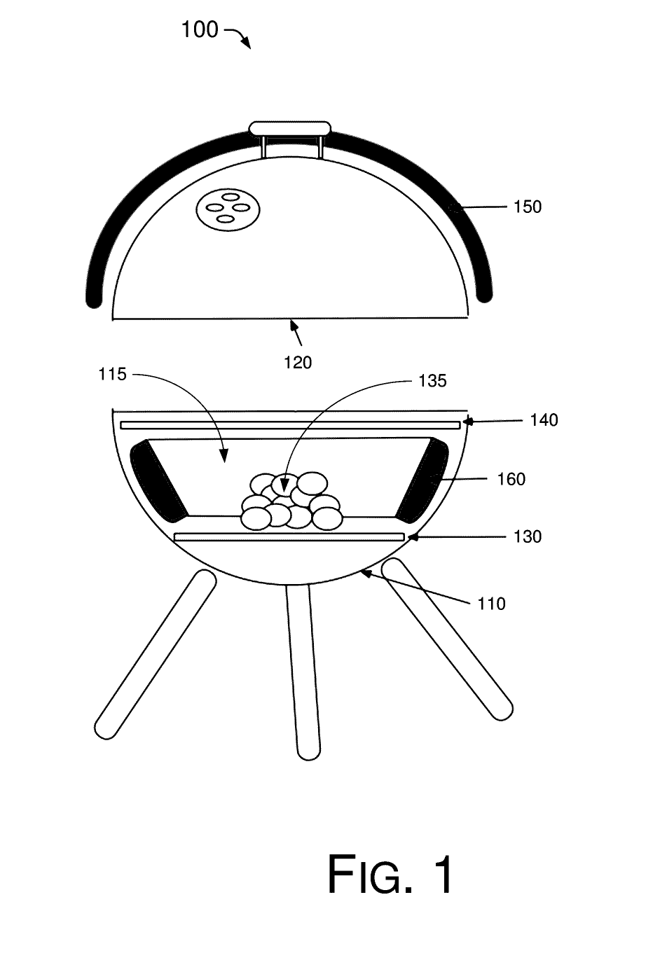

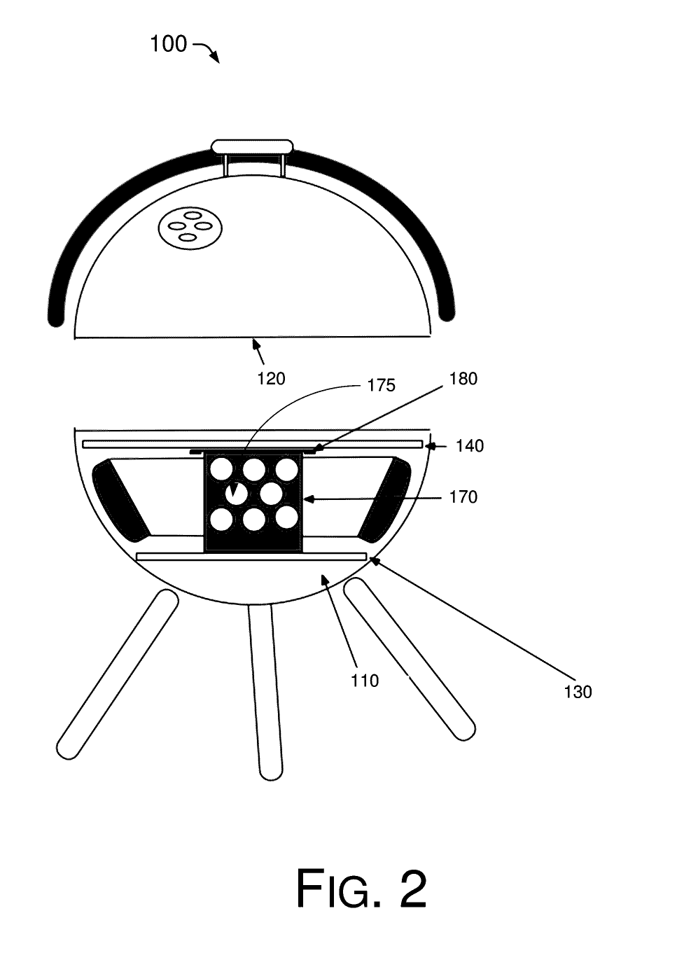

FIG. 1 is a cross-sectional view of an example grill 100 in accordance with an embodiment of the present disclosure. FIG. 2 is another cross-sectional view of example grill 100.

Referring to FIG. 1 and FIG. 2, example grill 100 may include a grill body 110, a lid 120, a lower grate 130, an upper grate 140, a thermal-insulating blanket 150, a thermal-insulating wall 160, a fuel holder 170 and a metal plate 180. The grill body 110 may have a hollow 115 therein. The lid 120 may be configured to be placed on the grill body 110 to form a cooking space therebetween. The lower grate 130 may be disposed in the hollow 115 of the grill body 110, and may be configured to hold a fuel material 135 (e.g., charcoal or another suitable fuel) thereon. The upper grate 140 may be disposed in the hollow 115 of the grill body 110 and over the lower grate 130. The thermal-insulating blanket 150 may be disposed on and around the lid 120. The thermal-insulating blanket 150 may include glass fibers, ceramic fibers or a combination thereof. Optionally, the thermal-insulating blanket 150 may further include thermal-insulating filling fibers. The thermal-insulating wall 160 may be disposed in the hollow 115 of the grill body 110 and between the lower grate 130 and the upper grate 140. The thermal-insulating wall 160 may surround at least a portion of an interior surface of the grill body 110. The thermal-insulating wall 160 may include a ceramic material or a thermal-insulating material. The thermal-insulating wall 160 may be made of a plurality of wall sections or, alternatively, a monolithic piece. The fuel holder 170 may be configured to hold the fuel material therein, and may be configured to be placed between the lower grate 130 and the upper grate 140. The fuel holder 170 may be generally cylindrical-shaped or generally column-shaped. An advantage of the fuel holder 170 being in a generally cylindrical shape or generally column shape is that the height of the fuel holder 170 may be all the way up near the bottom surface of the upper grate 140 so that the fuel holder 170 can hold or otherwise contain more fuel, e.g., charcoal or another suitable fuel, to provide much higher searing heat. The fuel holder 170 may include a number of ventilation openings 175 around a periphery thereof. The metal plate 180 may be configured to function as a diffuser, and may be disposed on the fuel holder 170. The metal plate 180 may be made of cast iron. The metal plate 180, functioning as a diffuser, allows re-gaining of direct heat surface area to be used for indirect heat cooking.

### Feature Highlight

In view of the above, a non-limiting listing of select features of various implementations of the present disclosure is provided below.

In one aspect, a grill may include a grill body, a lid, a lower grate, an upper grate and a thermal-insulating blanket. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid.

In some implementations, the thermal-insulating blanket may include glass fibers, ceramic fibers or a combination thereof. In some implementations, the thermal-insulating blanket may further include thermal-insulating filling fibers.

In some implementations, the grill may further include a thermal-insulating wall disposed in the hollow of the grill body and between the lower grate and the upper grate. The thermal-insulating wall may surround at least a portion of an interior surface of the grill body.

In some implementations, the thermal-insulating wall may include a ceramic material or a thermal-insulating material.

In some implementations, the thermal-insulating wall may include a plurality of wall sections.

In some implementations, the thermal-insulating wall may include a monolithic piece.

In some implementations, the grill may further include a generally cylindrical-shaped fuel holder configured to hold the fuel material therein. The fuel holder may be configured to be placed between the lower grate and the upper grate. In some implementations, the grill may additionally include a metal plate configured to function as a diffuser. The metal plate may be disposed on the fuel holder. In some implementations, the metal plate may be made of cast iron.

Alternatively, the grill may further include a generally column-shaped fuel holder configured to hold the fuel material therein. The fuel holder may be configured to be placed between the lower grate and the upper grate. In some implementations, the grill may additionally include a metal plate configured to function as a diffuser. The metal plate may be disposed on the fuel holder. In some implementations, the metal plate may be made of cast iron.

In another aspect, a grill may include a grill body, a lid, a lower grate, an upper grate, a thermal-insulating blanket and a thermal-insulating wall. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid. The thermal-insulating wall may be disposed in the hollow of the grill body and between the lower grate and the upper grate. The thermal-insulating wall may surround at least a portion of an interior surface of the grill body.

In some implementations, the thermal-insulating blanket may include glass fibers, ceramic fibers or a combination thereof. In some implementations, the thermal-insulating blanket may further include thermal-insulating filling fibers.

In some implementations, the thermal-insulating wall may include a ceramic material or a thermal-insulating material.

In some implementations, the grill may further include a fuel holder configured to hold the fuel material therein. The fuel holder may be configured to be placed between the lower grate and the upper grate. In some implementations, the grill may additionally include a metal plate configured to function as a diffuser. The metal plate may be disposed on the fuel holder.

In yet another aspect, a grill may include a grill body, a lid, a lower grate, an upper grate, a thermal-insulating blanket, a thermal-insulating wall, a fuel holder and a metal plate. The grill body may have a hollow therein. The lid may be configured to be placed on the grill body to form a cooking space therebetween. The lower grate may be disposed in the hollow of the grill body, and may be configured to hold a fuel material thereon. The upper grate may be disposed in the hollow of the grill body and over the lower grate. The thermal-insulating blanket may be disposed on and around the lid. The thermal-insulating blanket may include glass fibers, ceramic fibers or a combination thereof. The thermal-insulating wall may be disposed in the hollow of the grill body and between the lower grate and the upper grate. The thermal-insulating wall may surround at least a portion of an interior surface of the grill body. The thermal-insulating wall may include a ceramic material or a thermal-insulating material. The fuel holder may be configured to hold the fuel material therein, and may be configured to be placed between the lower grate and the upper grate. The metal plate may be configured to function as a diffuser, and may be disposed on the fuel holder.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A grill, comprising:
a grill body having a hollow therein;
a lid configured to be placed on the grill body to form a cooking space therebetween;
a lower grate disposed in the hollow of the grill body, the lower grate configured to hold a fuel material thereon;
an upper grate disposed in the hollow of the grill body and over the lower grate; and
a thermal-insulating blanket disposed on and around the lid.

2. The grill of claim 1, wherein the thermal-insulating blanket comprises glass fibers, ceramic fibers or a combination thereof.

3. The grill of claim 2, wherein the thermal-insulating blanket further comprises thermal-insulating filling fibers.

4. The grill of claim 1, further comprising:
a thermal-insulating wall disposed in the hollow of the grill body and between the lower grate and the upper grate, the thermal-insulating wall surrounding at least a portion of an interior surface of the grill body.

5. The grill of claim 4, wherein the thermal-insulating wall comprises a ceramic material or a thermal-insulating material.

6. The grill of claim 4, wherein the thermal-insulating wall comprises a plurality of wall sections.

7. The grill of claim 4, wherein the thermal-insulating wall comprises a monolithic piece.

8. The grill of claim 1, further comprising:
a generally cylindrical-shaped fuel holder configured to hold the fuel material therein, the fuel holder configured to be placed between the lower grate and the upper grate.

9. The grill of claim 8, further comprising:
a metal plate configured to function as a diffuser, the metal plate disposed on the fuel holder.

10. The grill of claim 9, wherein the metal plate is made of cast iron.

11. The grill of claim 1, further comprising:
a generally column-shaped fuel holder configured to hold the fuel material therein, the fuel holder configured to be placed between the lower grate and the upper grate.

12. The grill of claim 11, further comprising:
a metal plate configured to function as a diffuser, the metal plate disposed on the fuel holder.

13. The grill of claim 12, wherein the metal plate is made of cast iron.

14. A grill, comprising:
a grill body having a hollow therein;
a lid configured to be placed on the grill body to form a cooking space therebetween;
a lower grate disposed in the hollow of the grill body, the lower grate configured to hold a fuel material thereon;
an upper grate disposed in the hollow of the grill body and over the lower grate;
a thermal-insulating blanket disposed on and around the lid; and
a thermal-insulating wall disposed in the hollow of the grill body and between the lower grate and the upper grate, the thermal-insulating wall surrounding at least a portion of an interior surface of the grill body.

15. The grill of claim 14, wherein the thermal-insulating blanket comprises glass fibers, ceramic fibers or a combination thereof.

16. The grill of claim 15, wherein the thermal-insulating blanket further comprises thermal-insulating filling fibers.

17. The grill of claim 14, wherein the thermal-insulating wall comprises a ceramic material or a thermal-insulating material.

18. The grill of claim 14, further comprising:
a fuel holder configured to hold the fuel material therein, the fuel holder configured to be placed between the lower grate and the upper grate.

19. The grill of claim 18, further comprising:
a metal plate configured to function as a diffuser, the metal plate disposed on the fuel holder.

20. A grill, comprising:
a grill body having a hollow therein;
a lid configured to be placed on the grill body to form a cooking space therebetween;
a lower grate disposed in the hollow of the grill body, the lower grate configured to hold a fuel material thereon;
an upper grate disposed in the hollow of the grill body and over the lower grate;
a thermal-insulating blanket disposed on and around the lid, the thermal-insulating blanket comprising glass fibers, ceramic fibers or a combination thereof;
a thermal-insulating wall disposed in the hollow of the grill body and between the lower grate and the upper grate, the thermal-insulating wall surrounding at least a portion of an interior surface of the grill body, the thermal-insulating wall comprising a ceramic material or a thermal-insulating material;
a fuel holder configured to hold the fuel material therein, the fuel holder configured to be placed between the lower grate and the upper grate; and
a metal plate configured to function as a diffuser, the metal plate disposed on the fuel holder.
